(19) United States
(12) Patent Application Publication
(10) Pub. No.: US 2008/0302885 A1
(43) Pub. Date: Dec. 11, 2008

(54) Valve Arrangement for Shower Dispenser

(76) Inventor: Paul W. O'Brien, Tunkhannock, PA (US)

Correspondence Address: CHARLES A. WILKINSON, ESQ., 68 EAST BROAD STREET, P. O. BOX 1426, BETHLEHEM, PA, 18016-1426, US

(21) Appl. No.: 11/936,584

(22) Filed: Nov. 7, 2007

Related U.S. Application Data
(60) Provisional application No. 60/864,733, filed on Nov. 7, 2006.

(51) Int. Cl. B05B 7/26

(52) U.S. Cl. 239/310

(57) ABSTRACT

A device for dispensing bath and shower salts, oils and other additives into a shower water stream, which device utilizes an improved valve arrangement in which the path of the water into the additive container may be partially or completely blocked or completely open so that the amount of additives inserted into the water stream is more easily controlled.

### CROSS REFERENCE TO RELATED APPLICATION

This application claims the benefit of U.S. Provisional Application Ser. No. 60/864,733, filed Nov. 7, 2006.

### BACKGROUND OF THE INVENTION

1. Field of the Invention

The present invention relates generally to dispensers for adding measured quantities of bath salts, oils, and similar additive materials into the water stream of a shower head, and more particularly still to an improved valve arrangement for regulating the flow of the dispensed additive material into a water stream.

2. Preliminary Discussion

It has become popular in recent times to add bath salts and other products to a bath to improve the experience of bathing. It is also claimed that bath salts have several therapeutic effects, such as reducing stress levels, easing muscle aches and pains, and aiding in a obtaining a good nights sleep. Bath salts may also be used to improve cleaning of the skin, as a water softener, or as a vehicle for cosmetic agents. Fragrances, oils, coloring agents, foaming agents, and fizzing agents are common bath salt additives.

Although bathing in a tub of water containing bath salts may be relaxing, it is also time consuming, and many people today do not have the time to take a relaxing bath, and resort to a quick shower instead. There is thus a need for a device for simply and quickly introducing a selected substance such as a measuring quantity of bath salts, fragrances, oils and the like into a shower water stream. The improved mechanism of the present invention is intended to be coupled into the water supply pipe leading to a conventional style shower head, and is manually controlled so that the device may be activated only at the desired or appropriate times while showering.

### OBJECTS OF THE INVENTION

It is a primary object of the present invention to provide a dispenser mounted between a water line or conduit and shower head for dispensing controlled amounts of bath salts, oils, and similar additive materials into the water stream, which materials as a result are applied over the user's body while showering.

It is a further object of the invention to provide a valve arrangement for regulating the flow of such additive material, wherein the flow may be either turned off, set at an intermediate flow position, or a full on position.

A still further object of the invention is to provide an improved valve arrangement for regulating the flow of such additive material whereby when a generally circular valve housed in a circumferential valve sleeve or housing is rotated, a bore in the valve is either completely registered with, partially registered with, or not registered with apertures connecting the main water flow with the container in which the additive material is housed.

A still further object of the invention is provide such an improved mechanism which is constructed to permit the quantities of bath salts, oils, and similar additive materials to be replaced when empty in a simple and straightforward manner.

A still further object of the invention is to provide such an improved mechanism which is not only simple to install in existing shower bath assemblies, but which is relatively simple and inexpensive to construct and which may be sold at a relatively low price.

Still other objects and advantages of the invention will become clear upon review of the following detailed description in conjunction with the appended drawings.

### SUMMARY OF THE INVENTION

A device for dispensing bath and shower salts, oils and other additives into a shower water stream, which device utilizes an improved choked flow valve arrangement in which the path of the water into the additive container may be partially or completely blocked or completely open so that the amount of additives inserted into the water stream is more easily controlled. A channel extends from the main water supply path to a valve sleeve in which a valve body having a bore that is registrable with such channel is rotatably secured. The bore has another opening on the distal face of the valve body, offset from the center of such valve body, and a hole leading to cavity behind the valve sleeve is similarly offset. A second channel leads from such cavity to the container for holding the additives. When the valve body is turned using a handle the pairs of channels and openings in the valve body are either completely registered or aligned, partially registered or aligned, or not completely unregistered or unaligned, which arrangement enables the user to control the flow of water into the additive container, and thusly the rate at which the additive is introduced into the main water supply exiting through the shower head and over the user's body.

### BRIEF DESCRIPTION OF THE DRAWINGS

FIG. 1 is an exploded view of the dispenser device of the present invention.

FIG. 2 is a cross-sectional view from the rear of the dispenser device of the invention.

FIG. 3 is a cross-sectional view from the side of the dispenser device of the invention.

FIG. 4 is a side view of the dispenser device of the invention with the handle turned to an “off” position.

FIG. 5 is a side view of the dispenser device of the invention with the handle turned to an intermediate “on” position.

FIG. 6 is a side view of the dispenser device of the invention with the handle in a third “on” position.

FIG. 7 illustrates the position of the valve connected to the handle in the position shown in FIG. 4.

FIG. 8 illustrates the position of the valve connected to the handle in the position shown in FIG. 5.

FIG. 9 illustrates the position of the valve connected to the handle in the position shown in FIG. 6.

FIG. 10 illustrates a wall bracket for the dispenser device.

FIG. 11 illustrates a device support having a slide plate for attaching to the wall bracket shown in FIG. 10.

FIG. 12 illustrates a top view of the wall bracket and device support.

FIG. 13 is an isometric view of the dispenser device mounted in the two-piece bracket shown in FIGS. 10-12.

### DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. The invention is intended to cover alternatives, modifications, and equivalents, which may be included within the spirit and scope of the invention as defined by the appended claims.

It would be desirable to be able to simply and easily insert a controlled amount of liquid oil, bath salts, or the like into the water stream emitted from a conventional shower head, which material would be dispensed over the body of the person showering. The present inventor has conceived of a dispenser device for achieving this result having a unique valve arrangement that readily mixed the material into the water stream and in addition enables the user to control the amount of material injected into the water stream at one time.

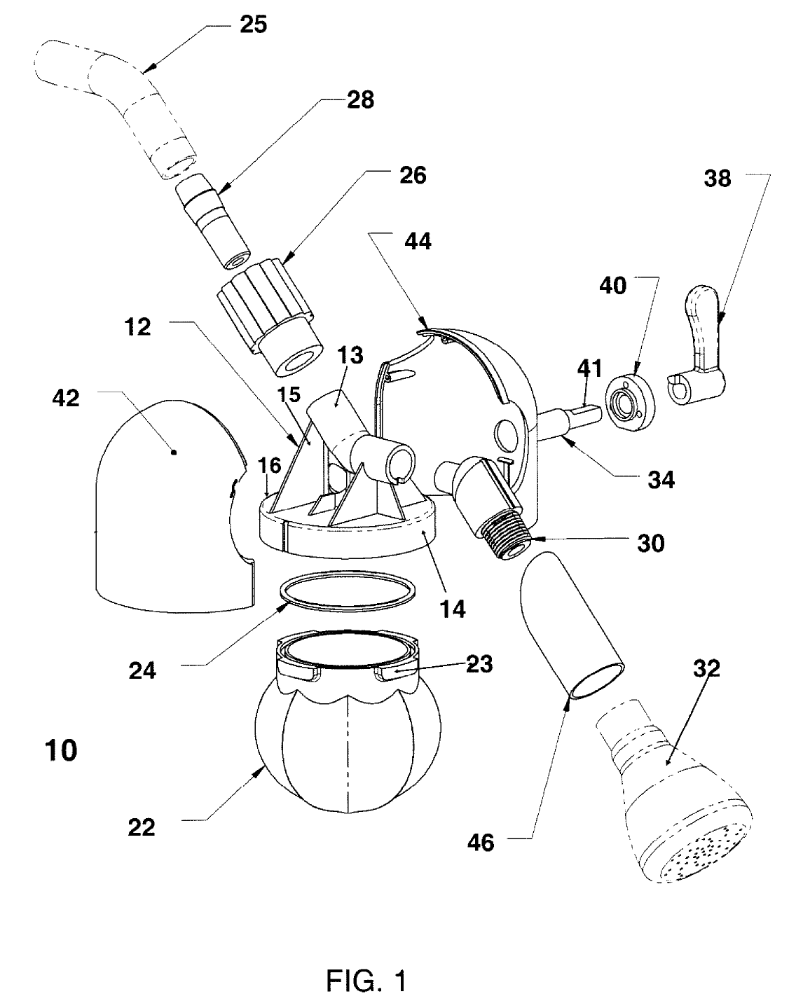

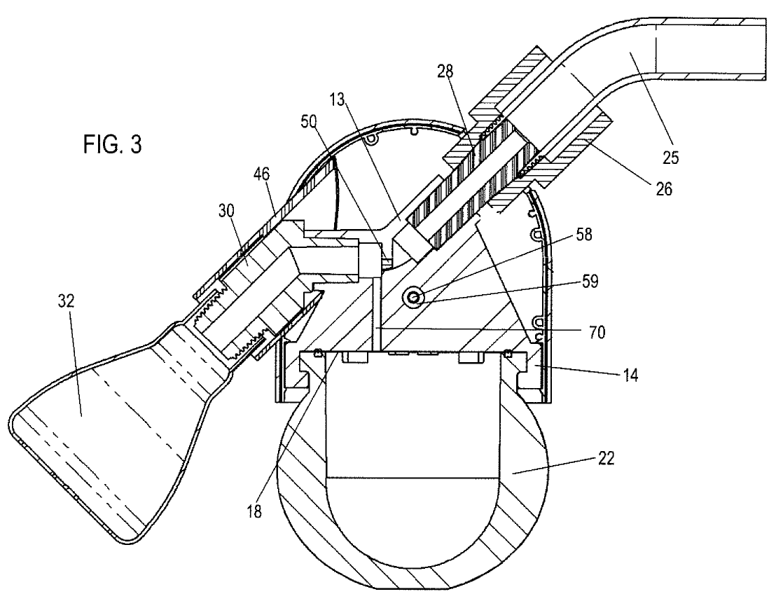

FIG. 1 is an exploded view of the dispenser device 10 of the present invention, which device is designed to be permanently and operably fixed between a shower water pipe mounted in the wall of a shower stall or similar area, and a shower head ordinarily attached to the end of such water pipe, so that water will flow from the water pipe through the dispenser device and then out of the shower head in a normal manner (see FIG. 3). In the following description, wherever reference is made to a location or part of the device as being “upstream” from another part or location, this generally refers to a location closer to the shower water line inlet, while where reference is made to a location or part of the device being “downstream” from another part or location generally refers to a location closer to the shower head.

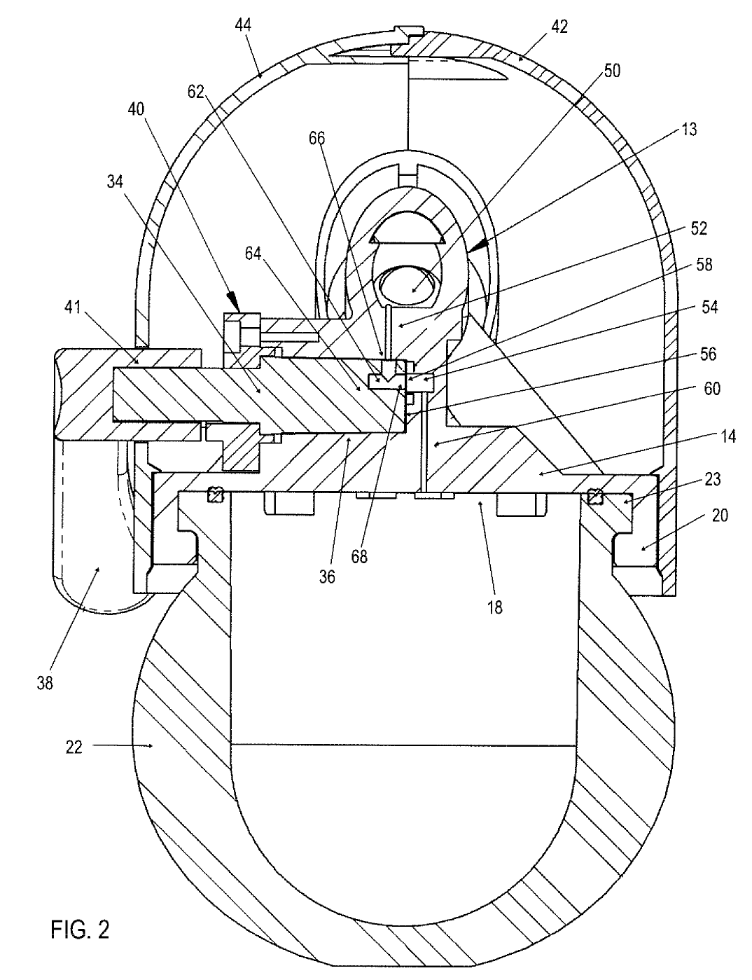

Dispenser 10 includes a main housing section 12 comprised of a valve 13 having a choked flow area and a round globe receiving lid 14, which parts are preferably integrally formed by injection molding, with several plates or members 15 connecting between the valve and lid for added strength. In addition, the majority of the operative parts of dispenser 10 are preferably formed using an injection molding process, although other materials such as metal or a combination of materials such as plastic and metal or any other suitable materials may be used to form such parts. Referring now both to FIGS. 1 and 2, globe receiving lid 14 has a top side 16, a bottom side 18, and an L-shaped lip 20 extending downwardly and then inwardly around the periphery of lid 14 for releasably receiving globe 22, which is open on its top. Several apertures (not shown) are provided in the inwardly extending flange of lip 20, which apertures are adapted to receive tabs 23 on the upper edge of globe 22, forming a preferably quarter-turn or twist locking arrangement between lid 14 and globe 22 by rotated tabs 23 under said lip. An O-ring 24 is preferably interposed between globe 22 and bottom side 18 of lid 14 when globe 22 is attached to lid 14 to prevent any leaking in such connection. Globe 22 is used to hold bath or shower salts, oils, or like materials which are to be mixed into a shower water supply to be dispensed over the body of those using the shower. Globe 22 is preferably made from molded plastic and be in different shapes and sizes, although an oval or rounded shaped is preferred. In addition, globe 22 is preferably transparent or translucent so that the user can see the bath salts or other material placed in the container, and in addition the mixing and dissolving of the bath salts in the container to be inserted into the water stream is also visible. Preferably, globe 22 will have ridges or other features on its outer surface to make it easier to grasp and twist to attach to lid 14, which is particularly important in a wet or slippery environment such as a shower stall.

The upstream end of valve 13 is connected to shower pipe 25 via female adapter 26, preferably utilizing a specially designed adapter tube 28 inserted into pipe 25 and adapter tube 26, which adapter tube 28 creates a stronger and more rigid connection with pipe 25, although a conventional male-female adapter arrangement may also be used. Similarly, the downstream end of valve 13 is permanently connected to the 30 upstream end of forty-five degree angled male adapter 30 by adhesive bonding or another suitable process, while shower head 32 is threadably secured to the downstream end of adapter 30. Thus, as best shown in FIG. 3, in such manner dispenser 10 is interposed permanently between shower pipe or line 25 and shower head 32. Dispenser 10 includes a mechanism for controlling the rate of flow of bath salts or the like being dispensed from globe 22 into the main flow of water from the shower pipe 25 through valve 13 and exiting through shower head 32. Such mechanism includes valve body 34 having handle 38 attached, which valve body 34 is secured in circumferential valve sleeve 36 (see FIG. 2) by retainer 40. Valve sleeve 36 is integrally formed with housing 12 and preferably extends outwardly generally perpendicular to the direction of the main water flow through valve 13. The shaft of valve body 34 has a flat section 41, and handle 38 has a matching flat section, which flat sections together ensure that handle 38 is secured in the proper or desired orientation on valve body 34. Although not critical to the operation of dispenser 10, generally rounded left and right side cover pieces 42 and 44 are secured over valve housing 12 to give the device an attractive rounded shape, while slidable chrome pipe cover 46 is situated over the connection between male adapter 30 and shower head 32. More particularly, cover 46 is slid upwardly (as shown in FIG. 3) to attach shower head 32 to adapter 30, and after such connection is tightened is slid downwardly over the connection to give hide the connection and improve device 10 aesthetically.

Referring now in particular to FIG. 2, which is a cross-sectional view of device 10 from the rear side at a position slightly upstream from a choked or restricted region 50 in valve 13 which results in a choked water flow through the device, the operation of the improved valve arrangement of dispenser device 10 will now be described. Bore or aperture 52 extends downwardly from valve 13 at a position slightly upstream from constriction 50, terminating at the edge of and opening into valve sleeve 36. Cavity 54 is positioned adjacent the rear wall 56 of valve sleeve 36, and which cavity 54 is connected to valve sleeve 36 by and aperture 58 (best shown in FIGS. 7-9) in rear wall 56 at a position offset from the center of rear wall 56, and which aperture 58 is surrounded by washer 59 (see also FIGS. 7-9), which washer also acts as a friction pump when lining up 58 and 68. Bore or aperture 60 extends downwardly from cavity 54 and terminates at the bottom side 18 of receiving lid 14, opening into globe 22 when connected to lid 14. Meanwhile, another bore 62 is provided in cylindrical valve body 34 near distal end 64 and at a position offset from the center of such valve body. More particularly, bore 62 has a first opening 66 on the side surface of the valve, and a second opening 68 on the rear surface or distal end 64 of the valve. The several apertures and openings just described are arranged so that side opening 66 of bore 62 in valve body 34 is registrable with bore or aperture 52, while distal opening 68 of bore 62 in valve body 34 is registrable with aperture 58 leading into cavity 54, depending on the orientation of valve body 34 at the time. As described below, such bores and apertures may be place out of registration, or in partial registration, by implementing a suitable manual rotation of valve handle 38 and in turn of valve body 34. In addition, as shown in the cross-sectional view from the side in FIG. 3, another bore or aperture 70 having a diameter greater than the diameter of bores or apertures 52 and 60 connects between valve 13 and the bottom surface 18 of receiving lid 14 at a location slightly downstream from constriction 50.

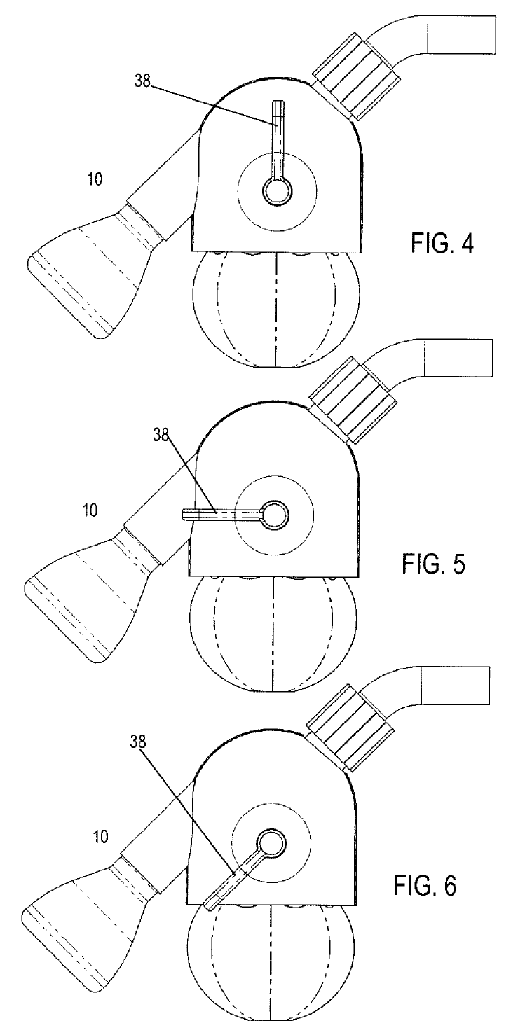

Referring now to FIG. 4-9, FIGS. 4-6 illustrate three possible positions for valve handle 38, while FIGS. 7-9 illustrate the corresponding positions of openings 66-68 in bore 62 in the distal end 64 of valve body 34 in relation to bore or aperture 50 and aperture 58 in the rear wall 56 of valve sleeve 36. When assembled, valve body 34 is secured in valve sleeve 36 by retainer 40, which retainer is fastened over the open end of sleeve 36 by screws or the like. Handle 38 is then secured to the proximal end of valve body 34, preferably by glue, screws, or other suitable connection arrangement, extending outwardly through retainer 40 such that when handle 38 is turned or rotated to one of the operative positions shown in FIGS. 4-6, valve body 34 will be coincidingly rotated a similar distance in sleeve 36. In such assembled configuration, the distal end 64 of valve body 34 is pressing tightly against washer 59 which surrounds aperture 58 leading into cavity 54 (shown in FIG. 3), creating a sealing arrangement. Valve handle 38 is rotatable between a first position shown in FIG. 4, a second or intermediate position, shown in FIG. 5, and a third position shown FIG. 6, with valve body 34 being similarly rotated in valve sleeve 36 between such positions. When valve handle 38 is in the position in FIG. 4, as shown in FIG. 7, opening 68 of bore 62 in the distal end 64 of valve body 34 is not aligned or registered with aperture 58 in the rear wall 56 of valve sleeve 36. In addition, opening 66 of bore 62 in the side wall of valve body 34 is not aligned or registered with aperture 52 connecting between valve 13 and valve sleeve 36. Thus, in such position, any water that is diverted down aperture 52 into the space between valve sleeve 36 and valve 34 is prevented from flowing further into bore 62 in valve body 34, then through aperture 58 into cavity 54, and then down into bore or aperture 60 through receiving lid 14 and into globe 22. Such position is therefore designated as the “off” position for dispenser 10, and thusly bath salts or the like are not dispensed from globe 22 into the main water flow.

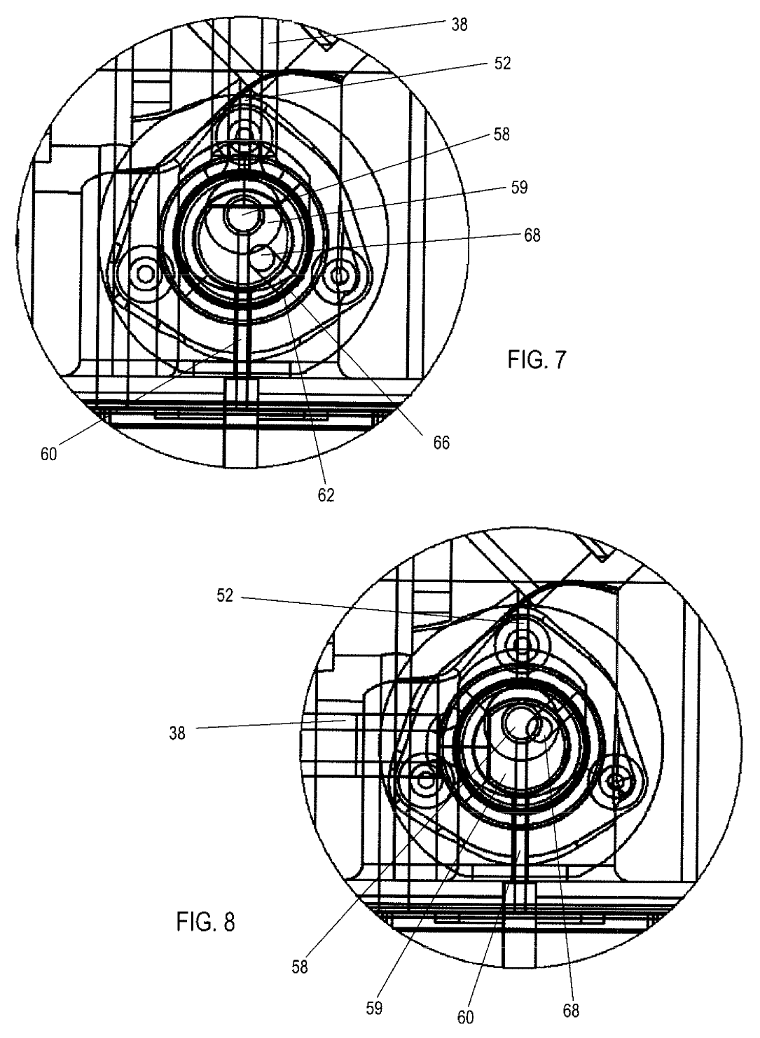

In FIG. 5, handle 38 is shown after is has been rotated to an intermediate position, which when such position has been reached is preferably indicated to the user by a “clicking” feeling in the handle, whereby a tab or friction bump on the interior side surface of retainer 40 is aligned in a notch on the outer surface of valve 34. At the same time, valve body 34 has now been rotated so that as shown in FIG. 8 opening 68 on the distal end 64 of valve body 34 is partially (but not completely) aligned with aperture 58 leading into cavity 54. Thus, water flowing down aperture 52 into valve sleeve 36 can now flow continually but not with full force further through bore 62 in valve 34, and then into cavity 54 and down bore aperture 60 into globe 22, where it mixes with the additive material in globe 22. In addition, such mixture of water and additive material can then flow upwardly out of globe 22 through aperture 70, where the mixture is inserted into the main water stream flowing through valve 13 to shower head 32. However, since there is only a partial alignment between opening 68 of bore 62 in valve 34 and aperture 58 leading into cavity 54, the quantity or flow of water through such opening is restricted, which resultingly limits the quantity or flow of the water and additive material mixture from globe 22 upwardly through aperture 70 and into the main water stream. Such position is thus considered an intermediate flow or “half on” position for dispenser 10.

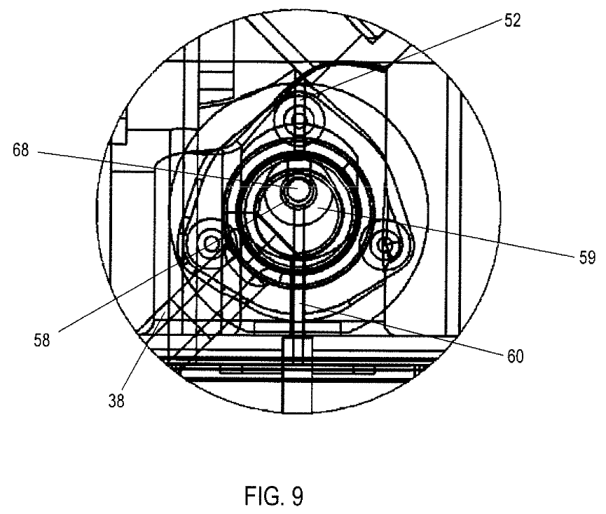

Finally, in FIG. 6, handle 38 is shown rotated past the intermediate position shown FIG. 5 to a third “full on” position. In such position, as shown in FIG. 9, opening 68 in the distal end 64 of bore 62 is completely overlapping or registered with aperture 58 leading into cavity 54. In addition, aperture 52 extending from valve 13 to valve sleeve 36 is also aligned or registered with opening 66 in the side wall of valve 34. Thus, water flowing from valve 13 down aperture 52 now has a clear path through bore 62 in valve 34 into cavity 54 and then down bore or aperture 60 connecting cavity 54 with the interior of globe 22. In addition, the water and additive material mixture in globe 22 will then flow at a higher rate upwardly through bore or aperture 70 exiting into valve 13 and the main water stream. Preferably, such bores and apertures are circular in cross-section, with the diameters being adjustable to affect the dispensing rate upon adjustment of the position of the valve body 34.

In use, after the dispenser 10 has been securely fastened to the water supply pipe 25 and shower head 32 has been secured fastened to dispenser 10, globe 22 is removed and filled with a suitable supply of bath salts, oils, or the like, which globe 22 is then connected securely to receiving lid 14 of valve housing 12 via the tabs 23 on the upper end of the globe and matching openings in lip 20 of receiving lid 14, with globe 22 being twisted a quarter turn or so until tabs 23 are positioned under lip 20. Then, with handle 38 of dispenser 10 being initially turned to the “off” position, the user can turn on or open the water flow from supply pipe 24, which stream of water will flow through the constriction or choked area 50 in valve 13 directly to shower head 32. As such time, water will also be caused to flow down bore or aperture 70 into globe 22, filling the globe approximately two-thirds to three quarters full or until the pressure of the air in the globe is approximately equals that of the water entering the globe. The bath salts or other additive material in the globe will now begin to dissolve and mix with such water. Then, when it is desired to mix the additive material into the main water flow, handle 38 is turned to either the intermediate position or full “on” position, as shown by the position of handle 38 in FIGS. 5 and 6, respectively. In such positions, water then also flows at either an intermediate or high rate downwardly through bore or aperture 52 connecting valve 13 with valve sleeve 36, passing through bore 62 in valve body 34 into cavity 54, and then downwardly through bore or aperture 60 into globe 22. Aperture 52 is positioned slightly upstream from choked area or constriction 50 in the valve 13, which increases the pressure at such position and causes the water to be forced downwardly into aperture 50. In addition, since while bore or aperture 70 is downstream in relation to constriction 50, the pressure at bore or aperture 52 in valve 13 will be greater than at bore or aperture 70, with the decreased pressure at aperture 70 being caused by the increased velocity of the water just after at such point due to constriction 50, which results an effect similar to the well-known “Venturi effect”. The decreased pressure results in aspiration of the water and additive material mixture in globe 22 upwardly through bore or aperture 70, while water continues to flow downwardly into globe 22 through the combination of aperture 52, bore 62 in valve 34, and aperture 60. The amount of the force of the water flowing into globe 22 can thus be regulated by turning valve 40 as described above. Eventually, all of the additive material and water mixture will have exited globe 22 through aperture 70 into the main water stream, where is will be dispensed through shower head 32 over the user's body, leaving a pleasant smelling scent or residue on such person. Handle 38 of dispenser 10 can then be moved to an “off” position, and globe 22 may be refilled with salts or the like for another shower.

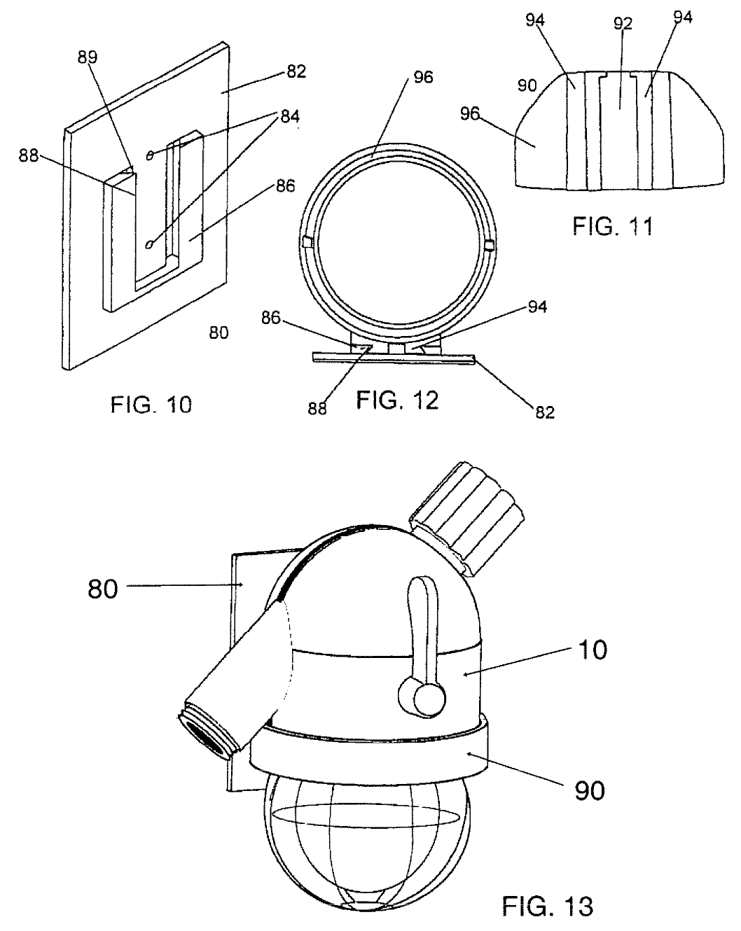

Dispenser device 10 can also be used with a hand held shower wand, rather than secured directly between a water outlet pipe and shower head. In such an arrangement, dispenser device 10 will be coupled on its upstream end to a water supply pipe by a flexible hose, and a hand held shower wand will be coupled to adapter 30 on its downstream end. In addition, device 10 will preferably be mounted to the wall of a shower stall in a suitable position, using as is illustrated in FIGS. 10-13 a two piece bracket including a wall bracket 80 and a dispenser support member 90, both of which are preferably made from plastic using an injection molding process. Wall bracket 80 includes a flat plate 82 having a pair of screw holes 84 for mounting the device to a shower wall in a usual manner, although alternatively, bracket 80 may be secured to the wall of the shower stall by other means such as gluing, or more preferably using a double side adhesive applied on the rear surface of plate 82. A U-shaped holder 86 for receiving slide plate 92 on dispenser support 90 is provided on the front surface of plate 82. Lip 88 of U-shaped holder 86 is undercut preferably at about a forty-five degree angle, forming channel 89 in which the matching tabs 94 of slide plate 92 are fitted. See FIG. 12. Sleeve 96 extends rearwardly from slide plate 92, and is secured, preferably permanently by gluing, around the lid section 14 of dispenser 14. Device 10 may then be used to mixed bath salts, oils, or other materials into the shower water has already been described above.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

I claim:

1. A device for dispensing an additive into a water stream at a controlled rate comprising:
a primary section including a main conduit having a choked flow area, a lid member for detachably holding a container filled with an additive to be introduced into the water stream, and a circumferential sleeve for receiving a valve body,
a first bore connecting between the main conduit upstream from said choked flow area and the circumferential sleeve,
a second bore connecting between the rear surface of said circumferential sleeve offset from the center of the sleeve and the lid member,
a valve body rotatably secured in the circumferential sleeve having a circumferential side surface, a distal end, and a proximal end, and an eccentric bore positioned near said distal end having a side opening and a distal opening offset from the center of said valve body,
said side opening being registrable with said first bore, and said distal opening being simultaneously registrable with said second bore, and
a third bore connecting between the lid member and main conduit at a position downstream from the choked flow area of said main conduit,
whereby depending upon the orientation of the valve body, water is permitted to flow into the additive holding container and said additive is caused to be mixed into the main water stream at a controlled rate.

2. The device of claim 1 additionally comprising a handle member attached to the proximal end of said valve body for rotating the valve body in said sleeve.

3. The device of claim 2 whereby said said valve body is rotatable to a position wherein the side opening and distal opening of the valve body are not in registration with said first bore and aperture in the rear surface of the valve sleeve, respectively.

4. The device of claim 3 whereby said valve body is rotatable to a position wherein the side opening and distal opening of the valve body are in partial registration with said first bore and aperture in the rear surface of the valve sleeve, respectively.

5. The device of claim 4 whereby said valve body is rotatable to a position wherein the side opening and distal opening of the valve body are in registration with said first bore and aperture in the rear surface of the valve sleeve, respectively.

6. The device of claim 1 additionally comprising an adapter attached downstream from said dispenser for securing a shower head to said valve housing.

7. The device of claim 6 additionally comprising an adapter upstream from said dispenser for securing said device to a water inlet pipe.

8. The device of claim 6 additionally comprising an aesthetic sleeve slidably secured over the shower head adapter between a first position wherein the connection between said adapter and the shower head are not covered by the sleeve, and a second position wherein the connection is covered.

9. The device of claim 1 additionally comprising a slide plate bracket system for securing the dispenser device to a support surface.

10. The device of claim 1 wherein said additive container is in the shape of a globe, and has ridges on its outer surface to facilitate grasping the container more securely.
